(19) United States
(12) Patent Application Publication
(10) Pub. No.: US 2002/0118950 A1
(43) Pub. Date: Aug. 29, 2002

(54) Method and apparatus for displaying video time-of-recording on the DVD player display

(76) Inventor: Fausto E. Molinet III, Salem, NH (US)

Correspondence Address: MESMER & DELEAULT, PLLC, 41 BROOK STREET, MANCHESTER, NH, 03104, US

(21) Appl. No.: 09/897,068

(22) Filed: Jul. 2, 2001

Related U.S. Application Data
(60) Provisional application No. 60/270,853, filed on Feb. 23, 2001.

(51) Int. Cl. H04N 5/781; H04N 5/783

(52) U.S. Cl. 386/68; 386/125

(57) ABSTRACT

A video storage medium for use in a video player has one or more video portions containing video data, at least one black frame portion in series with the one or more video portions and having duration time data, and program code stored on the storage medium. The program code is adapted to instruct the video player to skip over the at least one black frame to the beginning to the next one or more video portions.

### BACKGROUND OF THE INVENTION

1. Field of the Invention

The present invention relates generally to a method and apparatus for seamlessly reproducing a bit stream having no sequential system clock data therein. Particularly, the present invention relates to a method and apparatus for seamlessly reproducing a bit stream for use in an authoring system for variously processing a data bit stream comprising video data, audio data and sub-picture data constituting each of plural program titles containing related video data, audio data, and subpicture data content to generate a bit stream on optical disc having a real time of recording data. More particularly, the present invention relates a bit stream on optical disc and the program counter display of a DVD player.

2. Description of the Prior Art

In recent years, an enhancement in the density of a writable optical disc has been developed so that it has been possible to record video data as well as computer data and audio data. The conversion of recording media from tape into disc has various influences on the function and performance of an AV apparatus. The conversion into disc considerably enhances random access performance. If the tape is subjected to random access, it is necessary to usually take a time in order of several minutes for one rewinding. This is extraordinarily long compared to the seek time of 20-60 milliseconds or less for optical disc media. From a practical standpoint, tape cannot act as an efficient random access device. Thus, the development of optical disc media has allowed considerable flexibility in the creation and use of video data.

Authoring systems are used to convert tape audio/video data to optical disc format. Currently, there are available authoring systems used to produce program titles comprising related video data, audio data and sub-picture data by digitally processing, for example, multimedia data comprising video, audio and sub-picture data recorded to laser disk or video CD formats. Systems using video CDs in particular are able to record video data to a CD format disk, which was originally designed with an approximately 600 MB recording capacity for storing digital audio data only, by using such high efficiency video compression techniques as MPEG. As a result of the increased effective recording capacity achieved using data compression techniques, titles and other conventional laser disk applications are being transferred to the video CD format.

Users today expect both sophisticated title content and high reproduction quality. To meet these expectations, various methods and apparatuses have been developed.

U.S. Pat. No. 5,923,869 (1999, Kashiwagi et al.) discloses a system stream contiguous reproduction apparatus to which are input one or more system streams interleaving at least moving picture data and audio data, and system stream connection information includes a system clock STC generator for producing the system clock that is used as the system stream reproduction reference clock. The system stream contiguous reproduction apparatus further includes one or more signal processing decoders that operate referenced to the system clock STC, decoder buffers for temporarily storing the system stream data transferred to the corresponding signal processing decoders, and STC selectors for selecting a system clock STC referenced by the signal processing decoders when decoding the first system stream, and another system clock STC referenced by the signal processing decoders when decoding a second system stream reproduced contiguously to the first system stream.

U.S. Pat. No. 6,115,076 (2000, Linzer) discloses a method and system for capturing and compressing an original uncompressed video signal which enables decoding and reversible reconstruction of a decompressed version of the original video signal. The system includes an input for receiving a signal indicating a special effect operation by which a first frame of a video signal is irreversibly transformed to a special effect frame. This is achieved by combining decompressed frame pixel data of the first frame with information comprising either pixel data of a second frame or a single scaling value to be used to scale plural pixels of a frame. The information indicates a special effect operation which can be performed on decompressed pixel data of the first frame to produce a special effect frame.

European Patent Application 1,035,546 (2000, Okada et al.) discloses an information recording medium suitable for an optical disc such as DVD, which is capable of reading quickly the recording time information of the video data for displaying a menu. The recording medium stores management information for each stream data. The management information includes a recording time information that has a date and time at which the head video frame of the stream data is recorded. The management information also has an error information indicative of error or fraction of the recording time information which indicates a time less than one second and is generated on edit operation including partial deletion.

However, none of the prior art has addressed the ability of a DVD program counter display to be used to display time of recording of the original video recording.

Therefore, what is needed is a method and apparatus that is capable of displaying the original video recording time on the DVD program counter display and to allow random access selection of the time-of-recording of the original video.

### SUMMARY OF THE INVENTION

It is an object of the present invention to provide a method and apparatus with the ability to display the original time-of-recording of the video recording on the DVD program counter display. It is another object of the present invention to provide a method and apparatus that allows a user to randomly select a point in time of the original video recording time and to display the video as it occurred at about such selected recording time.

The present invention achieves these and other objectives by providing a method and apparatus to trick a DVD player's time output to display a time other than elapsed time of the DVD. When a DVD disc is inserted into a DVD player, the program counter on the DVD player displays a time zero in hours, minutes, seconds format. In other words, the DVD player displays 0:00:00, i.e. h:mm:ss, as the initial time display. As the DVD disc is played, the time increments.

Most video cameras have the ability to record the actual time of recording onto the videotape. This is accomplished by an on-board time clock built into the video camera mechanism. This time stamping/recording technique may be in military time or it may be in regular time, i.e. twelve hours in AM and PM. Recording the time of the video is important in many applications, especially in scientific applications. Because of the random access ability of DVD format, recorded video is increasingly being converted to DVD disc. Before the present invention, the time of recording could be reproduced and displayed on the video screen. However, using the program counter on the DVD player to display the time of recording shown on the video screen could not be done because of the DVD player's setting of the time display to 0:00:00 upon insertion of the DVD disc.

The present invention tricks the DVD player into displaying the actual time of recording in the program counter window. This is accomplished in the present invention by encoding a black frame at the lowest possible bit rate, i.e. 800 Kbps, for the time that is to be displayed. In other words, 0:00:00+h:mm:ss equals h:mm:ss. Any time counted from that point forward adds to the encoded time. This allows a time of day to be set for the time of day the video was recorded. Provided there are no breaks in the video, i.e. where the camera was shut off for a period of time, the time display on the DVD player will match the time of day of the original recording.

In the event the camera had been shut off and a break in time in the original video exists, another segment of video, i.e. an encoded black frame, is inserted that is equal in play length to the elapsed time the camera was not recording. A black frame is defined as a video portion made up of one or more video frames that is not presented to the viewer. However, this solution presented another problem. Total time could not exceed nine hours as this would fill up the DVD disc. An alternative and preferred solution to this problem was discovered. By using a slide show, a DVD player can be tricked into thinking that time had passed when it actually had not. The slide show allows the DVD player to count up from time zero to the first second of the time-of-day recording of the video. The video is queued in after the slide show. Any authoring software that supports slide shows and cell and precommands can be used.

The method of the present invention is to create a track for the first program chain (PGC), which is a slide show of one black frame. The duration of time for this frame is set to be equivalent to the beginning video recording time to be displayed. This track is added to the first PGC played. The track(s) containing the continuous-time video segment are then added after the slide show track. A “pre” flag, which is a set of commands that are executed before the title commands begin, is connected to point to the video segment. This “pre” flag causes the DVD player to by-pass the slide show track to the beginning of the video segment and sets the DVD player time display to the stored duration time.

In the event that the video segment is not time continuous, i.e. there is a break in the recording such that the camera was shut off for a given amount of time, another track is created with a time index equal to the time elapsed. This second slide show track, i.e. black frame, is inserted into the PGC. A cell link is then created to link the last video cell to the next video (non-black) cell, essentially skipping the viewing of the black frame but having the DVD player's time display show the time as if the time of play had elapsed. This effectively allows the DVD time display to continue to match the original time-of-recording on the video screen.

### BRIEF DESCRIPTION OF THE DRAWINGS

FIG. 1 is a diagram illustrating the structure of a recording band on a tape.

FIG. 2 is a diagram illustrating the method of the present invention using an authoring tool.

FIG. 3 is an illustration showing the hierarchy of a DVD recording on a disc.

FIG. 4 is a simplified illustration of the present invention showing a DVD track containing the black frame slide show with a link between areas of continuous video data streams.

FIG. 5 is a flowchart of the present invention illustrating the steps to create a DVD that allows the time display of a DVD player to show the original recording time of the video.

### DETAILED DESCRIPTION OF THE PREFERRED EMBODIMENT

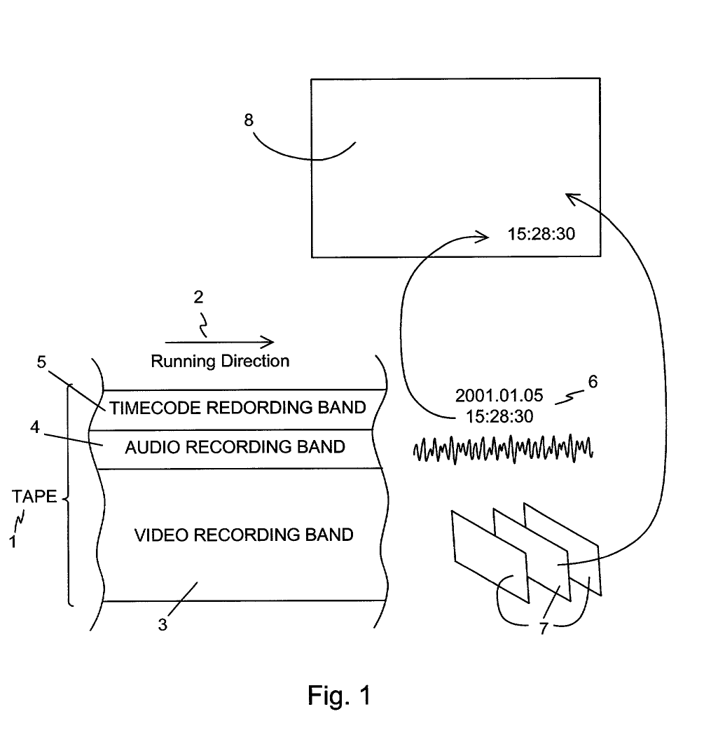

The present invention will now be described using FIGS. 1-5. FIG. 1 is a diagram illustrating a tape 1 that has conventionally been used widely for AV recording. The recording band of each data is assigned to tape 1 horizontally with respect to a running direction 2. Tape 1 has a video recording band 3, an audio recording band 4 and a time code recording band 5. A recording date 6 corresponding to each video frame 7 recorded in the video recording band 3 is recorded in the time code recording band 5. By displaying the time code information together with corresponding image information, a user can know what time an image that is being seen on a reproducing screen 8 was recorded.

When converting the data on an AV tape to DVD format, methods exist to display the recorded time of the original AV tape onto the reproducing screen, i.e. television screen, connected to the DVD player. As mentioned previously, the DVD player's time display will display the amount of time elapsed from a start time of zero when the disc is inserted into the DVD player to a given point in the DVD recording. This is a problem for a user who wants to view the video recording at a given recording time. For example, a particular video recording has an original, beginning video-recording time of 9:25:00 and is a continuous recording for approximately 6 hours. If a user wishes to arbitrarily see the video segment that was recorded at 11:27:00, the user must calculate the difference between the preferred viewing time and the start time of the original recording, then input this time difference into the DVD player to get to the location on the DVD disc that contains the video data with the original recording time of 11:27:00. However, this only works if the DVD start time of zero coincides with the beginning of the video data stream and so long as the video data stream was continuous, i.e. the video recorder was not shut off and restarted.

The present invention allows a user to simply input the original recording time into the DVD player that he/she wishes to have displayed on the reproducing screen and the DVD player will display the video stream that begins at the selected original recording time. Continuing with the above example, a user can simply input the original recording time of 11:27:00 into a DVD player that has a DVD disc made using the methods of the present invention and containing converted AV data from a tape recording. Upon selecting the original recording time of 11:27:00, the DVD player will display onto the reproducing screen the video stream data that begins at or near the original recording time of 11:27:00. Even if there are breaks in the original video recording time, the recording time video data at or near the original video recording time will be displayed.

It should be noted that the DVD player's capability to display the exact time inputted by the user is limited by the time coding mechanism used on DVD discs. When AV data is transferred to a DVD disc, there is encoded onto the disc a time code look-up table index having about 2,000 entries. The time differential between each entry in the look-up table for a particular disc is the same. The size of the lookup table is fixed by the software, which is governed by the standards in the industry. The time codes calculated and entered into the look-up table when the discs are made is determined by the software based on the total ending time of the AV data. For instance, if the total ending time is low (nine hundred hours=9:00:00), the time differential between each time code entry will be smaller than the time difference when the total ending time is high (twenty-four hundred hours=24:00:00). Thus, when a time is entered by a user, the DVD player will look in the time code index for the exact time or the next lower time, if there is no entry in the lookup table for the exact time, and display the video data onto the reproducing screen that is at or near the inputted time.

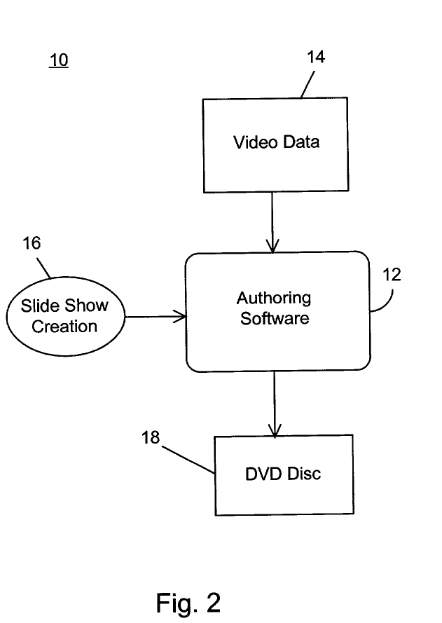

FIG. 2 is a block diagram of the components used in creating a DVD disc using the methods of the present invention. The components of the system 10 includes an authoring software 12, a video data 14 for input to the authoring software 12, a user input 16 to create a black frame with a set duration time, and a DVD disc recording component 18 for recording the black frame slide show and the audio/video data stream onto a DVD disc. Any authoring software that is capable of supporting slide shows, and cell and “pre” flag commands can be used. An example of such an authoring software package is sold under the trademark Scenarist and is available from Daikin U.S. Comtec Laboratories, Novato, Calif.

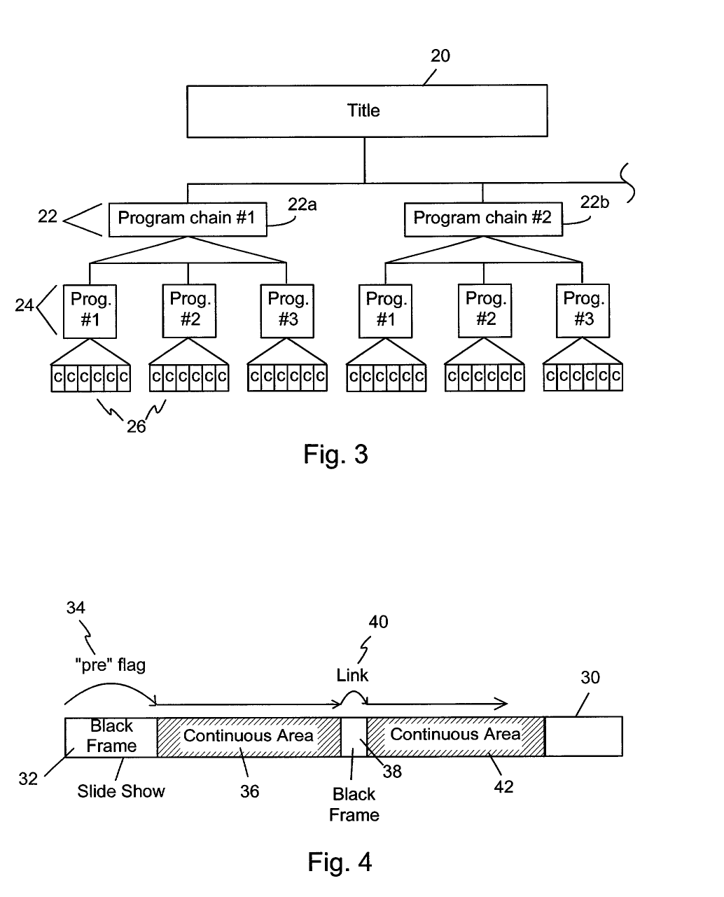

FIG. 3 illustrates the hierarchy of the data stored on a DVD disc. Each disc has a title 20 as the upper most hierarchy. Each title 20 is made up of one or more program chains 22, shown as program chain #1 22a, program chain #2 22b, etc. Within each program chain 22 are one or more programs 24. Each program 24 contains a plurality of cells 26. The plurality of cells 26 contains one or more of the video stream data, the audio stream data and the time code data. Prior to the beginning of play of the DVD disc, the disc contains a set of commands called “pre” flag commands. The “pre” flag commands are basically a set of programming code that may contain title and chapter information of the data stored on the disc (i.e. the contents of the disc) and code to generate a menu, table of contents and the like and to display some of this information onto the reproducing screen. The “pre” flag commands execute before the title program executes.

The authoring software allows a user to create links known as cell commands that execute after the cell is played. These links generally are the commands that point to the next cell to play. However, each cell represents a position on the DVD disc and the position on the DVD disc is related to the elapsed time. One method of the present invention that permits the DVD player's time display to display the original recording time of the video data is to provide a black frame for the length of time into the DVD disc that is equal to the first original recording time. For example, if a video recording was original started at 5:00:00 o'clock, a black frame having a duration of time of five (5) hours could be recorded on the disc. At the five-hour point on the disc, the video stream data would begin. Unfortunately this is not completely satisfactory, especially when original recording time is say 10:00:00 o'clock. DVD discs typically have a total recordable duration time of about 9 hours. It becomes even more of a problem if military time, i.e. a 24-hour clock, is used.

It was discovered that the slide show feature of the authoring program that is capable of supporting slide shows can be inserted in a DVD and a set duration time of the slide show can also be programmed onto the disc. What was discovered is that a slide show segment or frame can be encoded at the lowest possible bit rate (800 Kbps) for the time that is desired to be displayed. This technique then tricks the DVD player into displaying the duration time, which can be any time, of the encoded frame without taking up valuable DVD disc real estate.

FIG. 4 is a simplified representation of the method of the present invention. A portion of the data contents of the DVD disc is represented by the horizontal band 30. The left side of band 30 represents the beginning of the DVD disc. The leftmost block 32 is the black frame that contains the blank slide show and the time of duration data. The “pre” flag commands 34 instruct the DVD player to point to the location that is the beginning of the video stream data. This effectively causes the DVD player to skip over the black frame without the user viewing it while at the same time looking up the duration time data of the black frame and displaying that time on the time display of the DVD player. This fools the DVD player into thinking that time has passed when, in fact, it has not. In reality, it actually is just the same frame played for a given amount of time.

The first continuous area 36 contains the video stream data that is continuous for a given time and that was obtained from the videotape. If the video recording is not continuous, then another slide show black frame 38 is included with time of duration data that is set equal to the elapsed time that occurred between the time when the video recorder was shut off and then turned on again. A cell link 40 links the first continuous area 36 to a second continuous area 42 and bypasses the viewing of slide show black frame 38. This allows the user to continue to input the actual time of recording into the DVD player and to view the video data that was recorded at that particular time of day. The time-of-day readings shown on the screen will be the same shown on the DVD player's time display. These black frame slide shows can be inserted on the DVD disc at each point where the recording done by the video tape recorder was shut off for a time.

Some DVD players such as a SONY brand player resets the time display each time a new chapter is encountered on the DVD disc. To get around this problem, a black frame slide show with a set time of duration equal to the time at the end of the previous chapter may be inserted to display the original recording time of the video. This entails a little more work on the part of the technician because more black frame slide shows may be needed than would be required with other DVD players that do not reset the time display to provide the benefits of the method of the present invention. It should be understood by those skilled in the art that the present invention requires the use of a DVD player that allows searching by time.

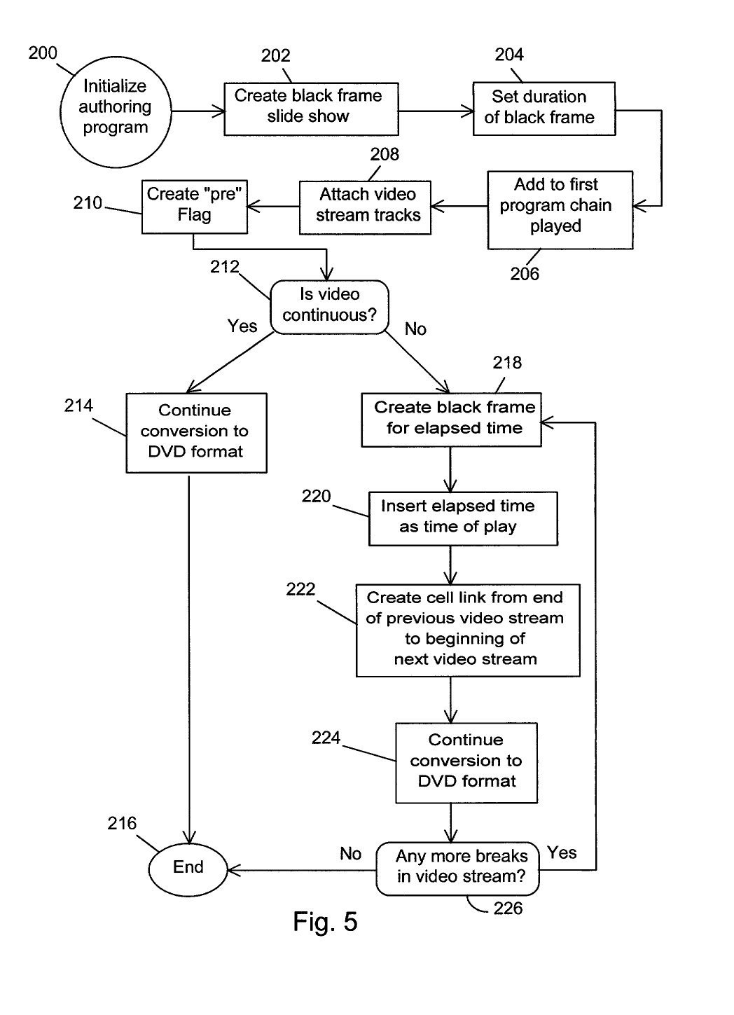

Turning now to FIG. 5, there is shown a flow diagram illustrating the method of the present invention. To convert a recorded videotape to DVD format, a DVD disc is created using authoring software. To create a DVD disc that contains audio/video stream data with the actual time of video recording and that displays the actual time of video recording on the DVD player's time display, an authoring software that supports slide shows, and cell and “pre” commands must be used. The method involves initializing such an authoring software program at step 200. After initialization, a black frame slide show is created at step 202 and encoded at the lowest possible bit rate for the time that is desired to be displayed. At step 204, the playtime duration of the black frame is set. At step 206, the black frame slide show is added to the first program chain to be played. After adding this black frame slide show, the continuous video stream tracks are attached at step 208. A “pre” flag is then created at step 210 and stored on the DVD disc that instructs the DVD player when the disc is played to skip the black frame slide show and jump to the beginning of the video stream, thus by-passing the viewing of the black frame while setting the DVD player's time display to the period of duration stored with the black frame slide show. At step 212, the technician determines if the time-of-day recording of the video stream is continuous. If it is continuous, the conversion from the tape format to DVD format continues at step 214 until the conversion of all of the video stream data is complete. When complete, the process ends at step 216.

On the other hand, if the original recording time of the videotape is not continuous, then, at the first break in the recording time, another black frame slide show is created at step 218. At step 220, the duration of play time that is set for this black frame is equal to the elapsed time that occurred when the original video recording was shut off and then turned on again. At step 222, a cell link is created that links the end of the previous continuous video stream to the beginning of the next continuous video stream. Conversion to DVD format continues at step 224. During the conversion process, if any more breaks in the recording time exists, then at step 226, the process loops back to step 218 to insert another black frame slide show. This black frame slide show creation loop occurs for each break in the continuous time-of-day recording time of the original videotape. When no additional time breaks occur, the DVD format conversion continues until all of the video data has been converted and the process ends at step 216.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A video storage medium for use in a video player, said storage medium comprising:
one or more video portions having stored therein video data comprising one or more video frames wherein each of said one or more video frames has a predetermined duration and wherein said video data is capable of being decoded and presented;
at least one black frame portion having duration time data capable of being received by said video player, said at least one frame portion being in series with said one or more video portions; and
program code stored on said storage medium, said program code adapted to instruct said video player to skip over said at least one black frame portion to the beginning of said one or more video portions.

2. The video storage medium of claim 1 wherein said at least one black frame portion is encoded at the lowest available bit rate.

3. The video storage medium of claim 2 wherein said lowest available bit rate is 800 Kbps.

4. The video storage medium of claim 1 wherein said at least one black frame contains duration-of-play information that indicates the duration time for said at least one black frame.

5. The video storage medium of claim 4 wherein said program code is further adapted to read said duration-of-play information of said at least one black frame portion and to cause said video player to display said duration-of-play information on a time display of said video player.

6. A method of displaying video time-of-day recording time on the display of a video player, said method comprising:
inserting a video storage medium into said video player wherein said video storage medium has a video portion with video data comprising one or more video frames with a predetermined duration, a black frame portion in series with said video portion, said black frame portion having a duration time substantially equal to the time-of-day at the beginning the next sequential video stream and having program code associated therewith wherein said program code is adapted to present said duration time wherein said duration time is received by said video player and is displayed on a display of said video player and adapted to instruct said video player to skip over said black frame; and
inputting time-of-day data to said video player thereby causing said video player to present said video data on said video storage medium associated with said time-of-day when said video data was recorded, wherein said time-of-day is substantially similar to said duration time presented by said video player.

7. A method of making a video medium capable of displaying time-of-day recording time on a display of a video player, said method comprising:
using authoring program code capable of using cell and pre-flag commands with video data frames;
creating a black frame having a duration time substantially equal to the time-of-day when a video data portion began recording video data for said video data portion;
providing program code associated with said black frame wherein said program code provides said black frame duration time to said video player; and
providing program code associated with said black frame wherein said program code provides commands to said video player to skip said black frame to the beginning of a next sequential video data stream recorded on said video medium.

8. The method of claim 7 further comprising creating one or more black frames wherein each of said one or more black frames has a duration time substantially equal to the recorded time-of-day at the beginning of the next sequential video data stream of said one or more black frames.

9. The method of claim 7 further comprising encoding said black frame at the lowest available bit rate.

10. The method of claim 7 further comprising encoding said black frame at a bit rate of about 800 Kbps.
